(19) United States
(12) Patent Application Publication
(10) Pub. No.: US 2014/0012591 A1
(43) Pub. Date: Jan. 9, 2014

(54) Systems and Methods for a Destination-Based Care Services Model

(71) Applicants: Andrew M. Kaboff, Vernon Hills, IL (US); Steven A. Wegner, Bartlett, IL (US); Michael Turoff, Chicago, IL (US); Michael K. Wons, Naperville, IL (US)

(72) Inventors: Andrew M. Kaboff, Vernon Hills, IL (US); Steven A. Wegner, Bartlett, IL (US); Michael Turoff, Chicago, IL (US); Michael K. Wons, Naperville, IL (US)

(73) Assignee: CELLTRAK TECHNOLOGIES, INC., Schaumburg, IL (US)

(21) Appl. No.: 13/543,499

(22) Filed: Jul. 6, 2012

(30) Foreign Application Priority Data
Jul. 6, 2012 (CA) 2,782,272

(51) Int. Cl. G06Q 50/22

(52) U.S. Cl. 705/2

(57) ABSTRACT

Examples disclose systems and method for a destination-based care services model. The method may be executable to receive from a computing device location data associated with a plurality of patients, and identify a task associated with one or more of the patients. The method may be further executable to determine that a patient task has been initiated and subsequently paused prior to completion of the patient task. Moreover, the method may be executable to detect that the patient task was later resumed, and determine a total time to complete the patient task. An alert may be generated if the total time to complete the patient task is outside of an allowable threshold.

### CROSS-REFERENCE TO RELATED APPLICATIONS

This application claims priority to Canadian Patent Application No. (to be assigned, reference number 12-593-CA, Systems and Methods for a Destination-Based Care Services Model), filed on Jul. 6, 2012, all of which is herein incorporated by reference.

### BACKGROUND

The home healthcare industry is a multi-billion dollar field. Instead of requiring patients to undergo prolonged hospital stays or frequent visits to a clinic, a home care agency brings the medical services to the patient's location. Payment for services rendered is primarily paid by federal and state Medicare and Medicaid programs or by private pay from insurance companies or individuals. Patient well-being often depends on the visit and attendance compliance of the visiting nurse, aide, or therapist, for example.

Home healthcare agencies dispatch nurses, aides, and therapists to the homes of patients to perform required healthcare assessments, tasks, and other vital services. The frequency and length of time of a visit and the care provided by the visiting professional are important to obtaining a positive outcome and improving the health of the patient. Government reimbursement to a home healthcare agency is paid on a per episode (sickness) basis; therefore, the visiting nurse is often required to recommend the frequency and type of visits by a care provider. Thus, it is important to ensure compliance by the care provider in attending the needed visits, and knowing what tasks and services are required for the specific patient. Tracking the duration of the actual visit is also important. Homecare agency administrators are then responsible for processing patient visit data records generated by the visiting staff to be transferred into billing, scheduling, and payroll systems.

Certain home healthcare reporting systems and processes rely on the visiting staff to self-report their visit attendance performance. Disadvantageously, at times this results in increased miscommunication, fraud, and abuse by the visiting care provider. The administrative staff of the home healthcare agency is faced with monitoring the off-site personnel by spot-checking visit attendance data or relying on patient complaints or feedback.

Another disadvantage to such self-reporting procedures is that the reporting is generally self-documented by visiting staff on paper reports. A full time visiting staff employee can perform over 1250 visits a year, which could require a typical administrative staff person to spend an average of ten minutes or more per employee visit to process and enter the information into appropriate billing, scheduling, and payroll systems. This can be inefficient and costly. Accordingly, there is a need for a system that provides for improved monitoring, reporting, data communication, and/or tracking of information relating to field service personnel such as visiting staff in the home healthcare field.

Systems have attempted to address the above noted disadvantages via an electronic system that allows the visiting staff to enter information associated with a patient. These electronic systems require that the visiting staff begin and complete scheduled tasks during a scheduled visit. Such systems may be useful when a single staff member is aiding a single patient at a location; however, such systems become problematic when the single staff member must aid multiple patients located at the same location. One reason that problems may occur is because the single staff member may have competing interests at the location that require the staff member to stop and come back to the patient.

As an example, a staff member may be helping a dialysis patient in a nursing home. With current electronic systems, the staff member may be required to stay with the patient until the dialysis is complete to receive credit for aiding the dialysis patient. However, other patients in the nursing home may require assistance during the dialysis treatment. It would be beneficial if a system allowed the single staff member to aid multiple patients and receive credit for the time and/or tasks performed by the staff member.

### SUMMARY

The present application discloses, inter alia, systems and method for a destination based care services model.

Any of the methods described herein may be provided in a form of instructions stored on a non-transitory, computer readable medium, that when executed by a computing device, cause the computing device to perform functions of the method. Further examples may also include articles of manufacture including tangible computer-readable media that have computer-readable instructions encoded thereon, and the instructions may comprise instructions to perform functions of the methods described herein.

The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage medium.

In addition, circuitry may be provided that is wired to perform logical functions in any processes or methods described herein.

In still further examples, many types of devices may be used or configured to perform logical functions in any of the processes or methods described herein.

In yet further examples, many types of devices may be used or configured as means for performing functions of any of the methods described herein (or any portions of the methods described herein).

For example, a method may be performed by a computing system having a processor and memory. The method may be executable to receive, from a computing device, location data associated with a plurality of patients, including a first patient and a second patient. The method may be further executable to identify a task associated with the first patient and a task associated with the second patient. The method may be executable to determine that the task associated with the first patient has been initiated, paused prior to completion, and later resumed after performance of at least part of the task associated with the second patient. A total time spent on the task associated with the first patient may be determined, wherein the total time may include a summation of a time spent prior to the initiated task being paused and a time spent after the initiated task being resumed. The method may be executable to generate an alert based on the total time and send the generated alert to the computing device.

In another example, a system may include a computing system including a computer-readable memory and program instructions stored on the computer-readable memory and executable by at least one processor to cause the computing system to perform a number of functions. The functions may include: receiving location data associated with a plurality of patients, including a first patient and a second patient; identifying a task associated with the first patient and a task associated with the second patient; determining a schedule for performing the task associated with the first patient and the task associated with the second patient; detecting that the task associated with the first patient has been initiated; detecting that the initiated task has been paused prior to completion; responsive to the initiated task being paused, determining a modified schedule for performing the initiated task; and detecting that the initiated task has been resumed after performance of at least part of the task associated with the second patient.

In yet another example, a computer-readable memory may have stored thereon instructions executable by a computing device having at least one processor to cause the computing device to perform a number of functions. The functions may include: identifying a plurality of patients at a location; identifying a plurality of tasks associated with the plurality of patients; detecting that a first task of the plurality of tasks has been initiated; detecting a pause of the first task, wherein the pause indicates that the first task has been stopped and is incomplete; detecting a resumption of the first task, wherein the resumption occurs after a second task of the plurality of tasks has been initiated and is paused or completed; receiving an indicator that the first task is complete; and responsive to the first task being complete, determining whether to submit the completed task for payment.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 is a representative system diagram illustrating a home health point-of-care and administration system according to an embodiment of the present invention;

FIG. 2 is a simplified block diagram of a communication device, in accordance with an exemplary embodiment;

FIG. 3 is a simplified block diagram illustrating representative shared care delivery models;

FIG. 4 is a flow chart illustrating steps of an example method;

FIG. 5 illustrates an example schedule associated with one or more shared care delivery models;

FIG. 6 illustrates a flow diagram based on the example schedule of FIG. 5;

FIGS. 7a-7m show pictorial representations of a user interacting with a display screen for a mobile device, according to an example embodiment;

FIG. 8 shows a pictorial representation of a display screen for a web portal server computer, illustrating a login screen according to an example embodiment;

FIG. 9 shows a pictorial representation of a display screen for a web portal server computer, illustrating a dashboard screen according to an example embodiment;

FIG. 10 shows a pictorial representation of a display screen for a web portal server computer, illustrating an activities screen for a team according to an example embodiment;

FIG. 11 shows a pictorial representation of a display screen for a web portal server computer, illustrating a pending alerts screen according to an example embodiment;

FIG. 12 shows a pictorial representation of a display screen for a web portal server computer, illustrating a performance screen according to an example embodiment; and

FIG. 13 shows a pictorial representation of a display screen for a web portal server computer, illustrating a map according to an example embodiment.

### DETAILED DESCRIPTION

In the following detailed description, reference is made to the accompanying figures. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

There are a variety of home healthcare models for providing services to patients. Example models include one-to-one care, one-to-many care, and/or many-to-one care. One-to-one care models include a single care provider interacting with a single patient, e.g., at the patient's home. One-to-many care models include a single care provider caring for multiple patients that may be in the same location, such as an assisted living facility, nursing homes, or the like. Many-to-one care models include multiple providers in a single location that are caring for a single patient, such as at a hospital or clinic. The systems and methods described herein focus on the one-to-many model, but may be implemented in any of the above noted models.

The one-to-many model may also be referred to as shared care, clustered care, or neighborhood care. A primary characteristic of a shared care is that care services may be provided by homecare agencies at a location that contains multiple patients to be visited by one care provider. Example locations may include any geographic location such as a building, facility, geographic grouping of homes, etc. The duration of each visit may range from minutes to hours. Due to having multiple patients at the location, the care provider may have an unpredictable care schedule. For example, a care provider may begin caring for a first patient and have to stop providing care to attend to second and/or third patient that may require more immediate care. The care provider may later resume caring for the first patient. This discontinuous and unpredictable schedule may continue until all of the care is completed.

Shared care is effective and funded by programs such as Medicaid, Medicare, and private payers. The difficulty, however, becomes keeping track of tasks performed for each patient and an amount of time spent performing each task for compensation purposes. The systems and methods described herein address this issue by maintaining and processing data on multiple patients, tasks performed for each of the patients, time spent performing the tasks, determining whether too much or too little time was spent performing the tasks, determining whether the tasks were completed, etc.

The processes described herein allow for care providers to begin, stop, resume, and end a patient visit in a random order, thereby allowing a care provider to begin a visit, pause to help another patient, and return to complete the previously initiated task. While this random order of care delivery includes stopping and starting, each of the visits insure a patient specific care plan has been executed and all of the time associated with the randomness of stopping and starting a visit is captured for effective reimbursement of the homecare agency and correct payment from Medicaid, Medicare, private payers, etc., for the services provided.

The systems and methods herein may implement the shared care model using a native application on a computing device, such as a smart phone, cell phone, tablet computer, notebook, personal digital assistant, or any number of other portable electronic devices that are capable of receiving one or more inputs, storing data, and/or manipulating data. Use of a native application may beneficially allow for remote policy management over the application and increased security as the native application need not be dependent on a hypertext markup language security mode. Moreover, use of a native application may allow for a richer user experience with increased functionality and automatic synching when the computing device is in and out of a coverage area. These benefits may be favorable over some browser based applications, which may have slow response times, be less secure, and require an Internet connection that may pose a problem when performing complex queries. However, it should be understood that the systems and methods described herein may be implemented using a native application or a browser based application.

The systems and methods described herein may be fully or partially configurable to an agency and cover multiple disciplines including health aides, social workers, therapists, nurses, physicians, chaplains, etc. Moreover, the systems and methods may be device agnostic, carrier agnostic, and include a pre-built partner integration. As described in more detail elsewhere herein, the systems and methods may also include a portal or other interface that may be used to monitor, administer, and provide alerts based on data received from the computing device. For example, the portal may provide alerts if a care provider is late, and may also or optionally provide a visual schedule, location data, directions, geo-fencing, reporting and analysis tools, data management tools, etc.

Exemplary Systems

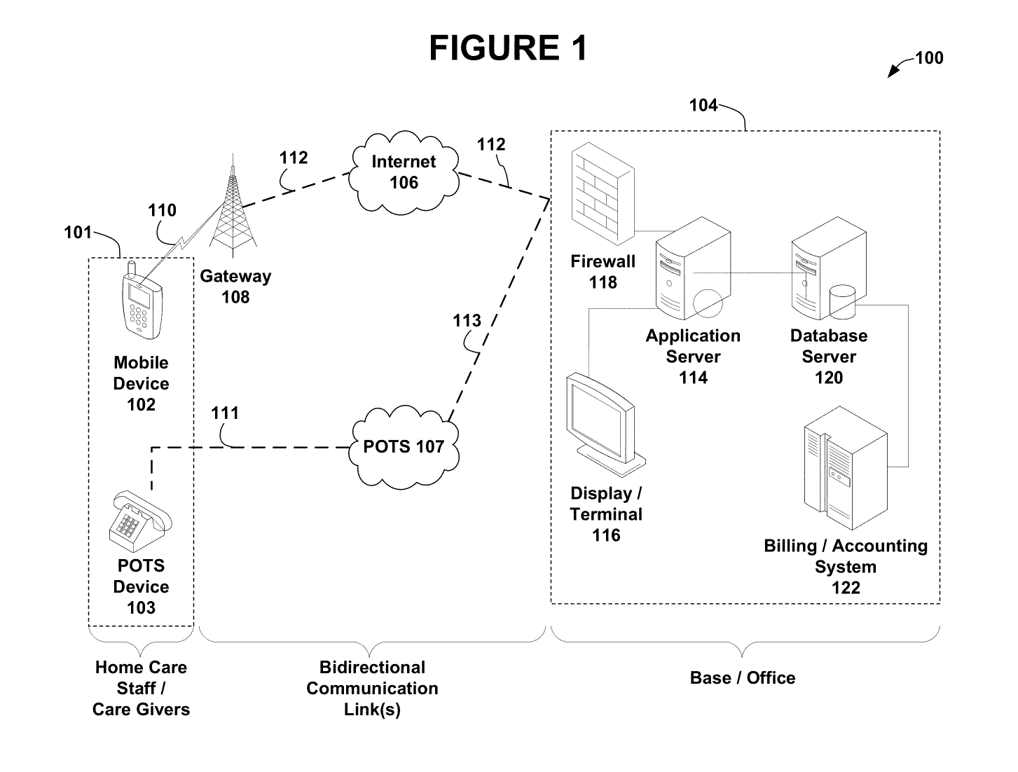

FIG. 1 illustrates an exemplary system for implementing the shared care model, in accordance with at least some embodiments described herein. As shown in FIG. 1, system 100 includes one or more mobile application devices 102 and/or plain old telephone system (POTS) devices 103 that may be used by a home-care staff person and/or care provider to bidirectionally communicate with base/office server system 104 over communication paths 110/112 and/or 111/113. Note that mobile application device 102 and/or POTS device 103 may be generically referred to as communication device 101. Moreover, in some examples, the mobile application device 102 may be referred to as a computing device.

Note that additional entities not shown in FIG. 1 could be present as well. For example, additional communication devices 101 could be present. As other examples, additional entities disposed along communication links 110, 111, 112, and/or 113 could be present, and/or additional server components could be present in server system 104. Also note that one or more of the entities shown in FIG. 1 could be combined into a single entity. For example, application server 114, firewall 118, database server 120, and/or billing/accounting system 122 could be part of a single server machine, and/or each could be a separate server machine, among other combinations and possibilities.

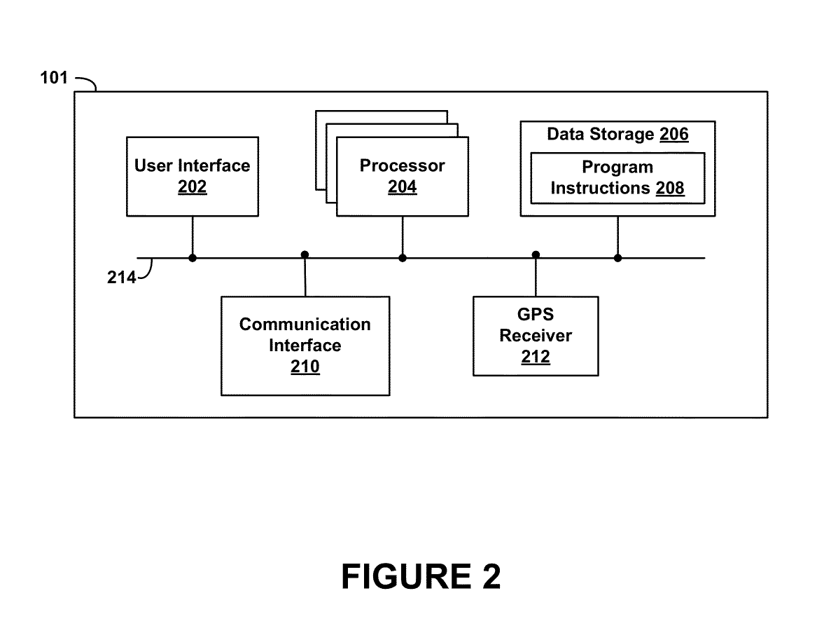

FIG. 2 is a simplified block diagram of communication device 101, in accordance with exemplary embodiments. Communication device 101 may be any device capable of carrying out the communication-device functions described herein. As such, communication device 101 may include user interface 202, processor 204, data storage 206 containing program instructions 208 that are executable by the processor, communication interface 210, and global positioning system (GPS) receiver 212, all connected by a system bus 214.

Other entities not shown in FIG. 2 may be present as well, including any other entities now known or later developed for such devices. For example, communication device 101 could include a modem, an imaging device, such as a digital camera and/or video camera, and/or an RFID (Radio-Frequency Identification) module. Further, communication device 101 may contain more than one of any one of the entities depicted in FIG. 2—for example, more than one processor. In embodiments, the program instructions 208 may include one or more objects and/or functions for performing the processes described herein.

Communication device 101 may take the form of or include a mobile device (such as mobile application device 102), a landline telephone (such as POTS device 103), a mobile phone, a personal digital assistant, a computer (such as a notebook computer), and/or an e-book reader, among other possibilities. Mobile application device 102 may be able to execute one or more applications, modules, and/or functions, perhaps using a processor and/or a data storage, and may take the form of a mobile phone, a smartphone, and/or a tablet computer, for example.

Communication device 101 may be used (and optionally carried) by each home-care staff person and/or care provider that operates in the field. These persons may include, for example, nurse aides, nurses, therapists, physician assistants, and other medical technicians and/or professionals.

User interface 202 may function to facilitate interaction with a user of communication device 101. As such, user interface 202 could include a keypad, a keyboard, a display, a touchscreen, a loudspeaker, and/or a microphone, and/or any other elements for receiving inputs and/or communicating outputs.

Processor 204 may be, for example, a general-purpose microprocessor and/or a discrete signal processor. Though processor 204 is described here as a single processor, those having skill in the art will recognize that communication device 101 may contain multiple (e.g., parallel) processors, as depicted in FIG. 2.

Data storage 206 may store a set of machine-language program instructions 208 that are executable by processor 204 to carry out various functions described herein. For example, program instructions 208 may allow communication device 101 to provide the following features:
Require a user to enter a username and/or password to prevent unauthorized access to the mobile device and underlying accessible patient data;
Exchange, update, approve, and/or deny staff schedules with the server system 104;
Transmit position updates to the server system 104, using a GPS module;
Accept a patient identification input from the user for an upcoming or current visit to the residence or current location of a particular home care patient;
Download from the server system 104 a patient-specific care plan corresponding to the particular home care patient;
Dynamically render one or more electronic data collection forms corresponding to the downloaded care plan;
Prompt the user to enter data corresponding to the electronic data collection forms;
Accept and validate data entered into the electronic data collection forms by the user;
Receive transmissions from telemedicine devices, such as Bluetooth-enabled weight scales, pacemakers, blood-pressure monitors, and others;
Transmit the entered data and/or completed electronic data collection forms to the server system 104;
Upon determining that no communication link is present, storing entered data offline (on the mobile device) for a period of time, until a communication link is again present;
Receive and display clinical messaging and/or notification from the server system 104;
Capture clinical images and/or video of patient features, such as surgical and wound conditions;
Accept voice annotations from the user, where the voice annotations may be associated with the captured clinical images or other data inputted by the user into the mobile device;
Accept supply order requests from the user and transmit the supply order requests to the server system so that they may be fulfilled; and
Receive messages and alerts from the server system 104 that relate to real-time health conditions for a patient undergoing a home care visit.

Alternatively, some or all of the functions/features could instead be implemented through hardware. In addition, data storage 206 may store various data to facilitate carrying out various functions described herein. In addition, data storage 206 may hold user-interface data, among many other possibilities.

Communication interface 210 may include a chipset suitable for communicating with one or more devices such as, for example, Internet 106, POTS 107, gateway 108, server system 104, and/or any entity. The communication interface could be suitable for wireless communication, such as GSM communication, CDMA communication, EV-DO communication, Wi-Fi communication, and/or Bluetooth communication, among other possibilities. Additionally or alternatively, the communication interface could be suitable for wired communication, such as Ethernet communication, POTS or public switched telephone network (PSTN) communication, universal serial bus (USB) communication, and/or FireWire communication, as well as other communication. Those having skill in the art will recognize that other types of communication may be possible without departing from the scope of the claims.

GPS receiver 212 could be, for example, any known or hereafter-developed GPS receiver, suitable for receiving and decoding GPS signals for location and timing purposes, perhaps among other purposes.

With reference again to FIG. 1, server system 104 may be any arrangement of one or more devices capable of carrying out the server-system functions described herein. The server system 104 in the illustrated embodiment includes application server 114 and an associated display 116, a firewall 118, a database server 120, and a billing/accounting system 122. The various entities that make up server system 104 may be communicatively connected via communication paths, which are described in detail below. The server system may also be connected to a network such as Internet 106 and/or POTS 107. Server system 104 may be a nation-wide centralized system that provides administration services for one or more home care offices throughout one or more different regions. Alternatively or additionally, each home care region could be serviced by one or more dedicated server systems 104. Multiple server systems 104 and/or multiple components within the server system 104 may be included in order to provide redundancy and/or load balancing.

Application server 114 may include, for example, a user interface (such as display/terminal 116), a processor, a data storage containing program instructions that are executable by the processor, and/or a communication interface, all connected by a system bus. The program instructions could include, for example, instructions for executing one or more functions and/or modules, among other possibilities. Additional elements could be present as well, and any of the described elements could be combined into a single element. Note that firewall 118, database server 120, billing/accounting system 122, or any other entity that makes up server system 104 could comprise a structure similar to that of application server 114.

Internet 106 may be any network capable of facilitating communication between communication device 101 and server system 104. As such, internet 106 could take the form of the wide area network commonly referred to as “the Internet.” POTS 107 may be any telephone network capable of facilitating telephone communication between communication device 101 and server system 104. As such, POTS 107 could be a PSTN, among other possibilities. Any other communication paths or system of paths that make up a communication network could be present as well to facilitate communication between communication device 101 and server system 104.

Gateway 108 may be any entity capable of carrying out the gateway functions described herein. As such, gateway 108 may comprise, for example, a cellular tower, a base station, a Wi-Fi access point, and/or an Internet gateway, among other possibilities, such that communication device 101 (such as mobile application device 102) may be able to communicate with gateway 108 via communication path 110.

Communication paths 110, 111, 112, and 113 may be used to facilitate communication between various entities, such as those entities depicted in FIG. 1. Though the communication paths are depicted as single, unbroken paths, those having skill in the art will recognize that a communication path may comprise multiple (parallel or serial) links.

Application server 114 acts as a server to communication device 101 and may be provided with a software based web server application that performs many actions such as dynamically managing workforce schedules; viewing open visits; viewing, editing and approving visits; archiving completed visits; and reporting based on monitoring and communicating visit information with communication device 101 used by care providers and or other home-care staff in the field.

Display/terminal 116 may be used by (for example) office-based staff to interact with application server 114, any other entity that makes up server system 104, or any other entity, and may be used to create, modify, and otherwise interact with care plans, patient information, staff schedules, and other data, among other possibilities. Examples of such devices 116 include desktop PCs, laptop computers, Tablet PCs, workstations, or any other devices. Display/terminal 116 may be capable of connecting to a World Wide Web server to retrieve and display web pages.

Database server 120 may selectively store various types of data that provide assistance in the management and administration of information, such as visit records and field service monitoring reports, obtained as a result of activities (such as home care visits) performed by care providers or other field service personnel or agents. The database server 120 may be coupled to a local or remote corporate billing/accounting system 122 to provide appropriate billing information based on tasks performed by the care provider and/or based on the shared care model associated with the patient and/or facility. A non-exclusive list of the types of information (fields) that may be stored in one or more databases includes: patient demographic information, home care tasks, staff information, locations, visit records, visit and/or task start time, visit and/or task pause time, visit and/or task resume time, visit and/or task end time, visit status, care plans, actual tasks that are performed in each actual visit, clinical outcomes, and clinical measurements. The one or more databases may comprise a Relational Database Management System. For example, a care plan may be maintained as a table having rows and columns corresponding to the stored fields. XML (Extensible Markup Language) based data structures with associated tags and metadata may be used for storing and sharing the home care information among the components of the system 100.

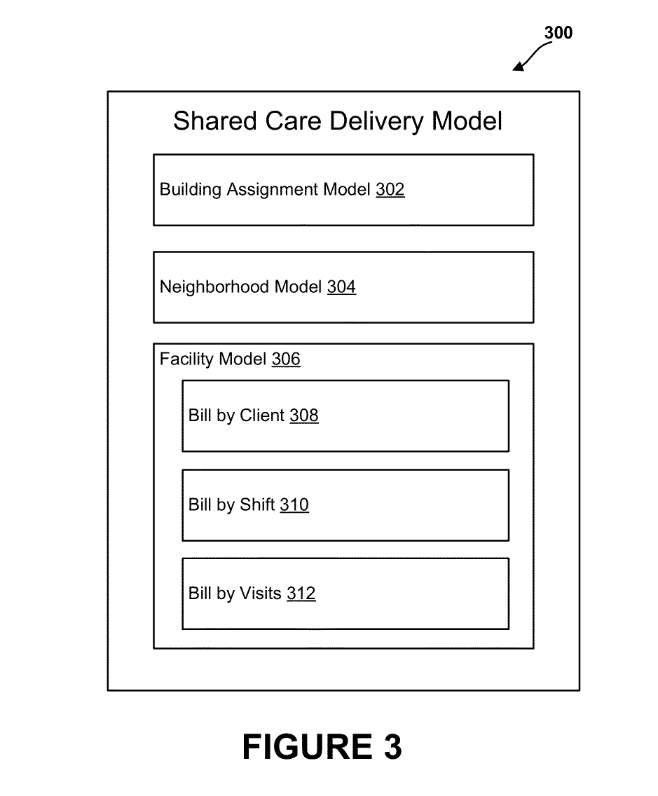

FIG. 3 is a simplified block diagram illustrating representative shared care delivery models, in accordance with at least some embodiments described herein. Specifically, FIG. 3 illustrates a number of models falling within the shared care regime. The models may include a building assessment model 302, a neighborhood model 304, and a facility model 306. The facility model 306 may be further broken down by billing practices, and include bill by client 308, bill by shift 310, and bill by visit 312. The systems and methods described herein are configurable to work with each of these delivery models for purposes of referral, staffing, and billing. In embodiments, the shared care delivery model may be utilized by the billing/accounting system 122 for purposes of generating a bill and/or compensating care providers.

The building assignment model 302 may include a care provider being assigned to a specific building. A block of time may be assigned to each client, such as a 30 minute block of time. The block of time may optionally be specific to a time, day of the week, and/or month. The block of time may be broken into chunks, such as a first 15 minute interval and a second 15 minute interval at a later time and/or date. Under a building assignment model 302, a care provider may go to the building and complete the care in any client order. Billing is for the block of time and care providers are paid by the client for the block of time.

The neighborhood model 304 may include a care provider being assigned to a specific neighborhood. For example, a care provider may be assigned to a shift within a building or set geography and see multiple patients within the neighborhood. The length of the shift may be determined by a predetermined amount of time per task for a patient. Thus, for example, a specific amount of time may be predetermined for a bath, taking blood pressure, changing linens, etc. Some or all of the tasks may be time specific, such as providing time dependent medications to a patient. Care providers are assigned shifts and may see a predetermined set of clients each shift. Care providers are paid by the shift and the client is billed for a predetermined time for each client task even though the task may take less than the predetermined time. Hence, as an for example, if a care provider has one hour to complete a task, but finishes the task in 45 minutes, the client will nonetheless be charged for the entire hour and the care provider will be paid for the entire hour. Conversely, a care provider taking over one hour to perform the task will only be paid for a single hour and the client will only be charged for the single hour.

The facility model 306 may broadly include a care provider being assigned to a specific facility. Within the facility model 306, the bill by client 308 model may include a care provider being assigned based on the patient, and may include specific and/or nonspecific times at which to perform a patient task. Billing may be for a predetermined time to complete the task, and the care provider may be paid based on the predetermined time. If the time taken to complete the task exceeds the predetermined time, adjustments to the bill and/or predetermined time may occur. For example, 17 service groups may be based on different time periods in a day, and a flat 300 hours per month per lodge may be allocated for various clients. If the time for a task exceeds the 300 hours per month, a bill adjustment may occur.

Also within the facility model 306 there may be a bill by shift 310 model, wherein a care provider may be assigned by building for a shift. The care provider may be scheduled to see a predetermined number of patients based on the building. The tasks may need to be performed at a specific time (e.g., intravenous drip feeds, hydration, dialyses, etc.); however, there may not be a predetermined amount of time allotted for each task. Billing may be by shift, and care providers may be paid by shift. Optionally, billing may be per visit for each time seen during a shift—with no specific dollar amounts attached to each visit. For example, a care provider may see ten patients in a five hour shift and make 17 total visits, wherein some of the patients are seen multiple times over the five hour shift.

The facility model 306 may also support a bill by visit 312 model, where a care provider may be assigned to a building for a shift and see a predetermined number of patients, as determined by the building and by the surrounding area. Tasks may need to be performed at specific time frames, such as in the morning, evening, at bedtime, etc. Overnight shifts may help address these specific time frames. Service providers may be paid per shift, and billing may be based on one visit per day per client with a total direct service time included. In examples, backup documentations may be kept by client per day per task with direct service time attached to each task. Overnight shifts may be billed, and a total number of hours per day for the whole week may be provided as a lump sum on an invoice with the total direct service attached.

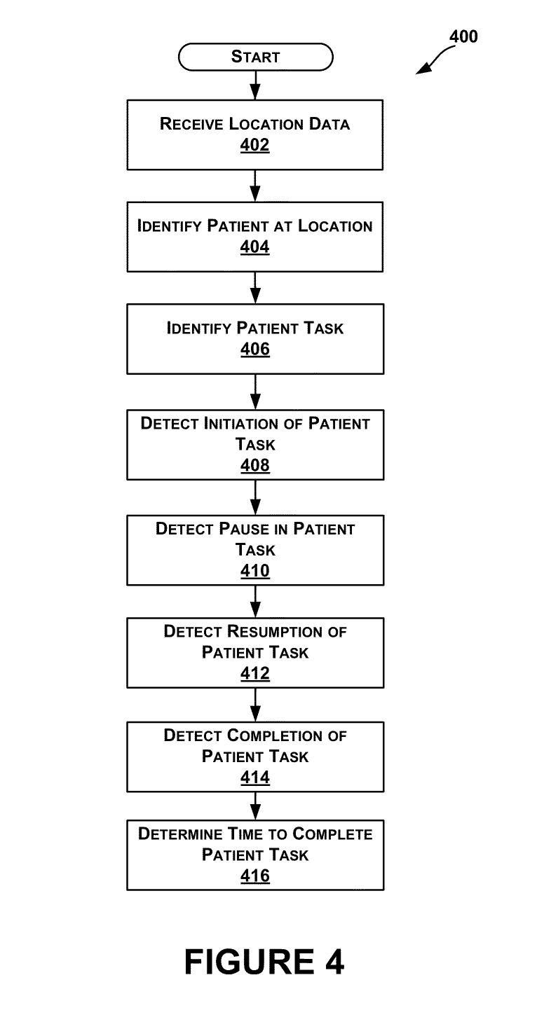

FIG. 4 is a flow chart illustrating steps of an example method, in accordance with at least some of the embodiments described herein.

Method 400 shown in FIG. 4 presents an embodiment of a method that, for example, could be used with the system 100, for example, and may be performed by a device, such as device illustrated in FIG. 1, or components of the device. Method 400 may include one or more operations, functions, or actions as illustrated by one or more of blocks in FIG. 4. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

In addition, for the method 400 and other processes and methods disclosed herein, the flowchart shows functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include a non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device.

In addition, for the method 400 and other processes and methods disclosed herein, each block in FIG. 4 may represent circuitry that is wired to perform the specific logical functions in the process.

At block 402, the method 400 includes receive location data. Location data may include data associated with a location, facility, building, neighborhood, etc., served by the shared care model. Location data may be obtained by a server system and be sent from: a care provider entering the location data into a computing device; the care provider selecting the location from a list of potential locations stored in a database at the computing device or at a database server; GPS or other satellite-based system in communication with the server system or a computing device; a radio-frequency identification tag (RFID); etc.

At block 404, the method 400 includes identify patient at location. Each location may be associated with one or more patients. The association may be via a database relationship at a server system. In embodiments, the patient may be identified based on: the database relationship; an identifier associated with the patient; a selection made by a care provider and received via a computing device; etc. For example, a care provider or other user may select a location and be presented with a list of potential patients at the location. The care provider may identify (e.g., via a selection mechanism) one or more of the patients from the list of potential patients. In another example, a patient may have an identifier, such as a card, RFID, or other token that may be presented to the care provider, available on a patient chart, outside of a patient door, etc., which may identify the patient at the location.

At block 406, the method 400 includes identify patient task. The server system may identify one or more tasks associated with one or more each patients via a database lookup. In some embodiments, the server system may also determine a schedule for performing the task(s). The schedule may be based at least in part on time constraints associated with the identified task(s), required or preferred order of tasks, etc. The schedule may be optimized using any number of polynomial complete or non-complete optimization algorithms.

At block 408, the method 400 includes detect initiation of patient task. The care provider may begin performing the patient task and send (e.g., via a computing device) a start indicator and/or start time indicative of the time that the task was initiated to the server system. The server system may receive the start indicator and use the start indicator to determine that the patient task has been initiated. The server system may store the start indicator and/or start time in a database server, for example.

At block 410, the method 400 includes detect pause of patient task. The care provider may pause the performance of the patient task prior to completion of the task. In such cases, the care provider may send (e.g., via a computing device) a pause indicator and/or a pause time indicative of a time that the task was paused. The server system may receive the pause indicator and use the pause indicator to determine that the patient task has been paused prior to completion of the task. The server system may store the pause indicator and/or pause time in a database server, for example. In embodiments, the server system may determine an amount of time that has elapsed between the initial start time and the pause time. This time may indicate an amount of time spent performing the task or visit up to the point at which the pause indicator was received.

In embodiments, the server system may determine a modified schedule for completing the task and/or performing other scheduled tasks. The modified schedule may be determined in a manner similar to that of determining the initial schedule.

At block 412, the method 400 includes detect resumption of patient task. The care provider may resume the performance of the patient task at any time after pausing the task. In doing so, the care provider may send (e.g., via a computing device) a resume indicator and/or a resume time indicative of a time that the task was resumed. The server system may receive the resume indicator and use the resume indicator to determine that the patient task has been resumed. The server system may store the resume indicator and/or resume time in a database server, for example.

In some examples, the resume indicator may be sent to the server system after the care provider has initiated, resumed, paused, and/or ended a different task, which may or may not be associated with the same or a different patient. Thus, as an example, the care provider may pause a task to go on break, and resume the task after the break is completed. As another example, the care provider may pause a first task associated with a first patient and thereafter initiate a second task associated with a second patient. The care provider may continue performing the second task associated with the second patient until the second task associated with the second patient has been paused or completed. The care provider may then resume the first task and continue performing the first task until the first task is paused or completed. It should be understood that any number of tasks may be performed in whole or in part while the first task is paused. Thus, for example, the first task may be paused while a third, fourth, fifth, etc., task and/or patient is aided in whole or in part—after which the first task may be resumed, paused one or more times, and/or completed.

At block 414, the method 400 includes detect completion of patient task. The care provider may complete the performance of the patient task at any time after initiating, pausing, and/or resuming the task. In doing so, the care provider may send (e.g., via a computing device) an end indicator and/or an end time indicative of a time that the task was ended or otherwise completed. The server system may receive the end indicator and use the end indicator to determine that the patient task has been ended or otherwise completed. The server system may store the end indicator and/or end time in a database server, for example. In embodiments, the server system may determine an amount of time that has elapsed between the resume time and the end time. This time may indicate an amount of time spent performing the task or visit after the task or visit was resumed.

At block 416, the method 400 includes determine time to complete patient task. The time to complete the patient task may include a summation of one or more times spent prior to the initiated task being paused and one or more times spent after the initiated task was resumed and then paused or completed. As an example, the total time to complete the patient task may include a summation of the time from receipt of the start indicator until receipt of the pause indicator and the amount of time that elapsed between receipt of the resume indicator until receipt of the end indicator. A total time may be determined and stored for each task, each visit, each patient, each location, etc.

In embodiments, there may be one or more predetermined or otherwise allowable times associated with each task, visit, location, etc. The allowable time may be determined based on the shared plan model, industry standards, reimbursement policies, etc. For example, an allowable time may be an amount of time that Medicare will reimburse a care provider for a service. The total time taken to complete the task may be compared to the allowable time. If the total time exceeds the allowable time, some insurers and/or shared care models may not provide compensation for the extra time spent completing the task. In embodiments, the server system may determine whether to submit the completed task for payment based on whether the total time taken to complete the task is within a specified or allowable threshold. If so, the total time is above a maximum allowable threshold, the task or visit may be billed. If the total time is below a minimum allowable threshold, an alert may be created and sent to an administrator, care provider, or other user, for example.

In some embodiments, the server system may generate one or more alerts and send one or more of the generated alerts to the computing device. For example, the server system may generate an alert based on the total time taken to complete a task or visit associated with one or more patients, wherein the alert is indicative of spending too much or too little time on the task or visit. Alerts may also be created, for example, when one or more tasks have not been completed within a predetermined amount of time, such as by the end of the care provider's shift. Moreover, alerts may be created upon a determination that all or part of a schedule or modified schedule has yet to be completed.

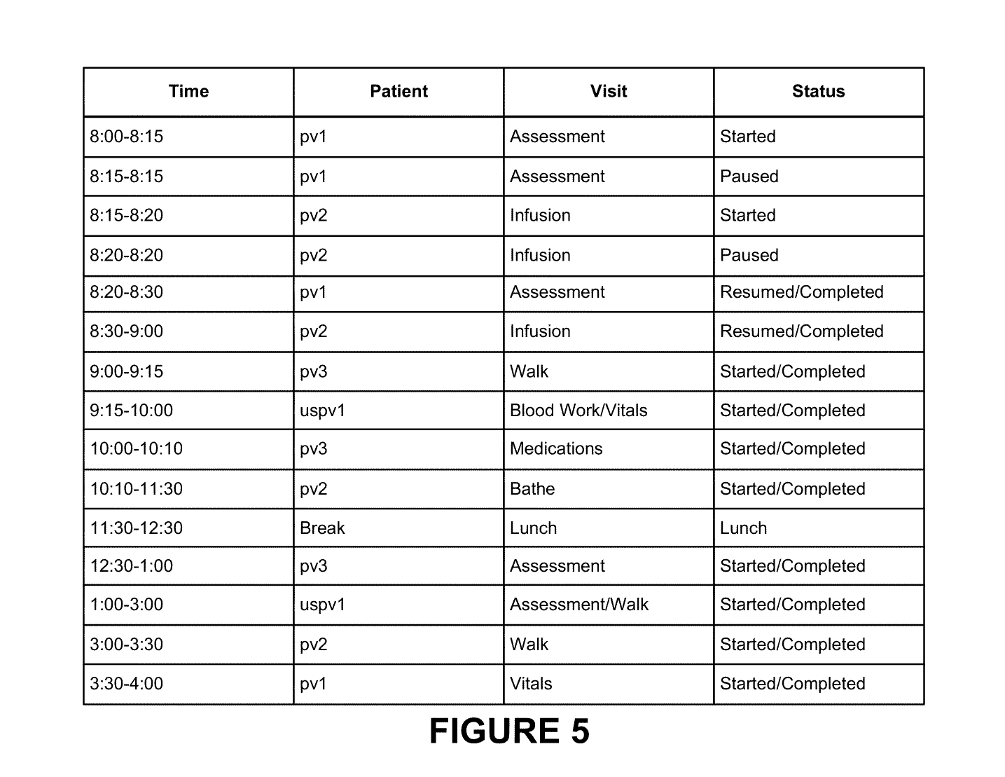

FIG. 5 illustrates an example schedule associated with one or more shared care delivery models, in accordance with at least some of the embodiments described herein. In particular, FIG. 5 illustrates a schedule that may be automatically created and/or modified based on one or more tasks that may need to be performed at a specific time, have been paused and later resumed, have been added or removed throughout the day, etc. Within FIG. 5, there includes a time, patient, visit, and status identifier. Depending on the shared care model being utilized, the time may be representative of a block of time, actual time spent performing a task, predetermined amounts of time for the task, etc. The patient may be indicative of a specific patient, and the visit may be indicative of a task that has been or is scheduled to be performed for the specific patient. In implementation, each visit may include one or more tasks, which may include one or more components to be completed prior to completion of the task. For example, an assessment may include the components of taking the patients temperature, weight, and blood pressure. The status may indicate whether the task has been started, paused, resumed, completed, etc. The status may also be used to represent breaks, non-billable tasks such as administrative duties, etc. In embodiments, the status may be selectable or otherwise definable using an input mechanism at the computing device and/or at the portal.

In an example, a care provider may begin a day by viewing on a computing device a list or schedule of tasks that may need to be performed during a visit for patient1 (pv1), patient2 (pv2), and patient3 (pv3). The care provider may then proceed by visiting patient1 and performing an assessment. The care provider may enter into the computing device an indication that the assessment (e.g., the task) began at 8:00 am. This time indication may be a time stamp created by the computing device upon notification from the care provider that the task has begun. Optionally, this time indication may be a time entered manually by the care provider. Other time indicators, such as the time associated with a pause indicator, resume indicator, end indicator, etc., may identify the respective pause, resume, end, etc., times in a similar manner.

At 8:15 am, the care provider may be informed by the computing device, a staff member at the location, a patient, etc., that patient2 needs to begin an infusion. Accordingly, the care provider may enter into the computing device a pause indication that the assessment has been paused at 8:15 am. The care provider may then communicate via the computing device an indication that the care provider is performing the infusion task for patient2 effective at 8:15 am. Once the infusion has been started, the care provider may pause the task at 8:20 am to return to patient1. At this point the care provider may send a resume indication to the computing device indicating that the previously paused assessment has been resumed or otherwise reinitiated. This may continue indefinitely until the computing device receives an end indication that the task is complete. As illustrated in FIG. 5, the completion of the assessment for patient1 occurs at 8:30 am and is followed by the care provider sending a resume indication to the computing device indicating that the previously paused infusion for patient2 is being resumed. At 9:00 am, the computing device may receive an indication from the care provider that the infusion has been completed. Thereafter, the care provider may indicate to the computing device that a walk for patient3 was initiated at 9:00 am and ended at 9:15 am.

In embodiments, the care provider may receive an indication that an unscheduled patient visit (uspv1) has been added to the care provider's schedule. The indication may be the addition of the new task to the care provider's schedule and/or may include an alert or other mechanism for notifying the care provider of the unscheduled patient visit. In some embodiments, the new task may be added by the care provider via the computing device, via an administrator or other party using a portal, etc. As an example, the care provider may be in the midst of a walk for patient3 and receive word that an unscheduled patient is feeling ill. The care provider may responsively enter information relating to the unscheduled patient visit uspv1 into the computing device along with an indicator that the unscheduled visit has started. In embodiments, the care provider may require approval prior to initiating the unscheduled visit. The unscheduled visit may proceed, be paused, be resumed, and/or completed similar to other tasks. Billing for the unscheduled visit may be processed by the systems described herein (e.g., by billing/accounting system 122) and be based on the shared care delivery model for the patient. The process of treating patients, pausing tasks, resuming tasks, and/or completing tasks may continue indefinitely until the scheduled (and any unscheduled) tasks are completed. In some examples, approval to complete a task another day or have a different care provider complete the task may be granted by an administrator or based on a predetermined set of rules.

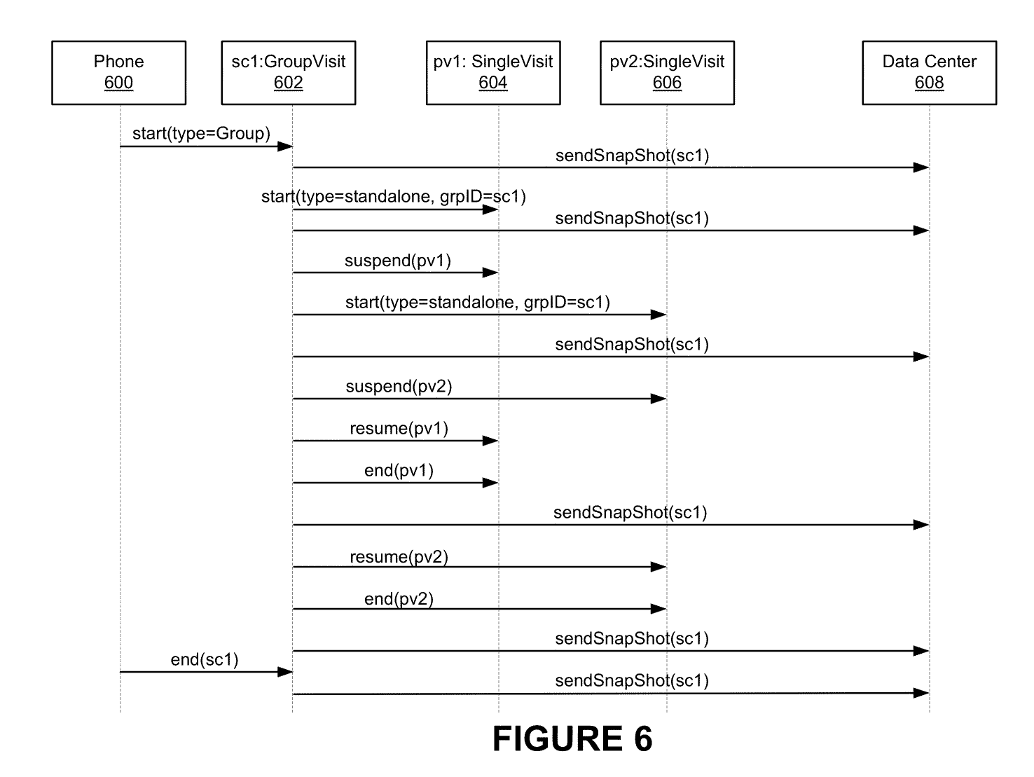

FIG. 6 illustrates a flow diagram based on the example schedule of FIG. 5, in accordance with at least some embodiments described herein. Specifically, FIG. 6 includes a phone 600 or other computing device. FIG. 6 also includes a group visit 602, which may be representative of one or more groups of patients, buildings, neighborhoods, facilities, etc. One or more patients, such as patient1 604 and patient2 606, may be associated with each group visit 602. As illustrated, the phone 600 and/or data center 608 may be structures such as mobile device 102 and database server 120, respectively. The group visit 602, patient1 604, and/or patient2 606 may be representative of data constructs or structures such as objects, which may send data to the data center 608 or facilitate the sending of data to the data center 608 via a function, for example. The objects and/or functions may be accessible or otherwise implemented by the phone 600, by a server, or by any number of computing devices.

A care provider may begin a shift by loading and/or opening a shared care application on the care provider's phone 600. This process may include the care provider specifying a group type such as a specific location or group being visited. Optionally, the group type may be identified based on historical selections, geographic location, groups the care provider typically services, etc. The group type may be received by a group visit 602 object or, for example, and the group type may be sent to a data center 608 as part of a snapshot conveying data associated with the care provider, the visit, etc. For example, the snapshot may include a time the program was initiated, a geographic location, etc. The data center 608 may receive and store the snapshot data. In embodiments, the data center may also return data to the group visit 602 object, which may be displayed via the phone 600. Example return data may include schedule or task updates relating to the group visit 602 and/or one or more patients.

The care provider may continue a shift by selecting a patient, thereby causing the phone 600 (e.g., via the group visit 602 object or related function) to send a start indicator to a patient1 603 object. The indicator may represent that a task (such as an assessment) associated with patient1 has begun and optionally include a start time associated with the time at which the task was initiated. All or part of this data may be sent to a data center 608 periodically, upon the happening of an event, or at sporadic intervals.

After a patient visit has started, the care provider may suspend the visit by entering a suspend indicator into the phone 600, which may be received at the group visit 602 object and sent to the patient1 606 object. The care provider may also enter a start indicator that a task associated with patient2 (such as an infusion) has begun. The suspension of the task associated with patient1 and the start of the task associated with patient2 may be sent to the data center 608, where the data center can process an amount of time spent performing the task(s) associated with patient1. Optionally, the amount of time spent performing the task(s) associated with patient1 may be tracked via a time function or the patient1 604 object. In examples, the data center 608 may return an altered schedule based on the suspended task.

The care provider may continue patient visits. As illustrated in FIG. 6, the care provider may suspend the patient2 infusion visit, and resume the patient1 assessment visit by sending a suspend indicator to the group visit 602 object followed by a resume indicator. In embodiments, sending a resume indicator prior to a suspend indicator or an end indicator may cause the group visit 602 object (or function associated therewith) to send a query to the phone 600 to determine whether the task associated with patient2 has been suspended or completed. A responsive indicator may be entered by the care provider and sent by the phone indicating whether the task has been suspended or completed. The responsive indicator may optionally include a care provider entered suspend or end time and/or an estimated suspend or end time.

The care provider may ultimately end patient1 visit. The phone 600, via group visit 602 object or function associated therewith, may send a snapshot to the data center, and the care provider may resume and ultimately end patient2's visit. A snapshot may then be sent from the phone 600, via the group visit 602 object or function associated therewith, to the data center 608.

Once the care provider is finished for the day or shift, the care provider may log out of or otherwise close the shared care application. Responsively, a snapshot may be sent from the phone via a group visit 602 object or functions associated therewith, indicating a state of each task in the schedule including whether each task has been completed, and any indicators associated with the scheduled tasks for the day. The data center may subsequently return an updated schedule showing the status of each task for the day, a schedule for the next day, etc.

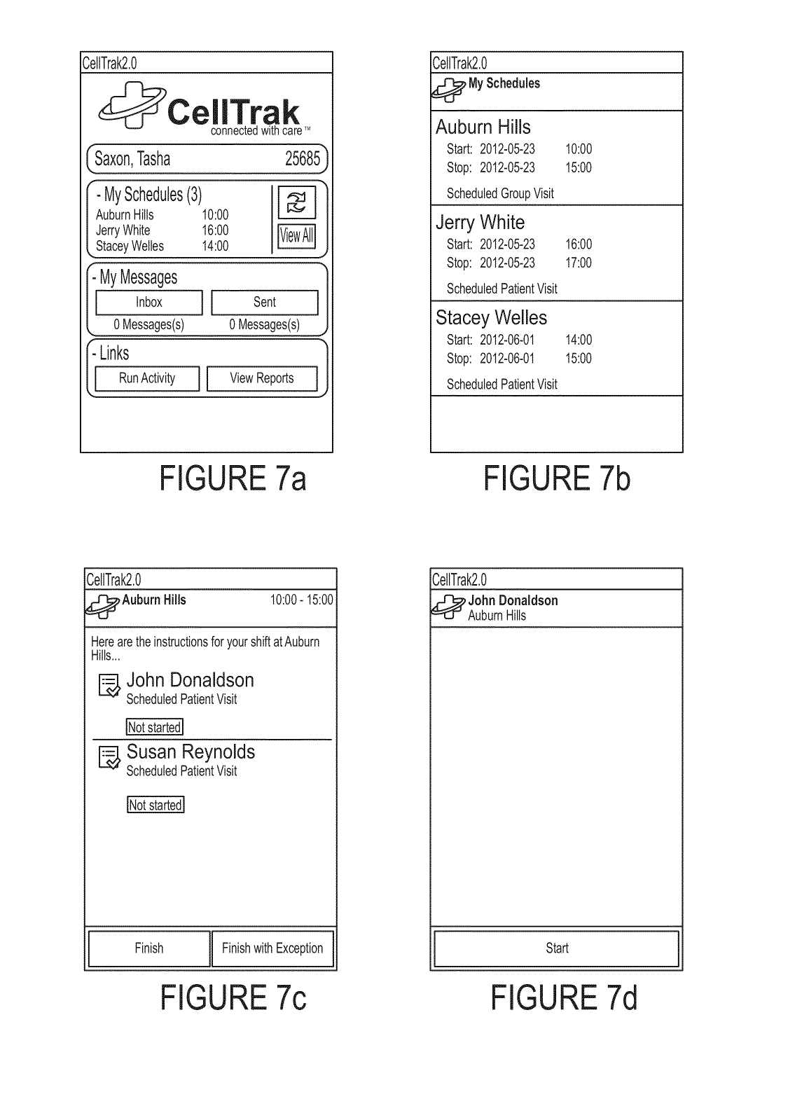

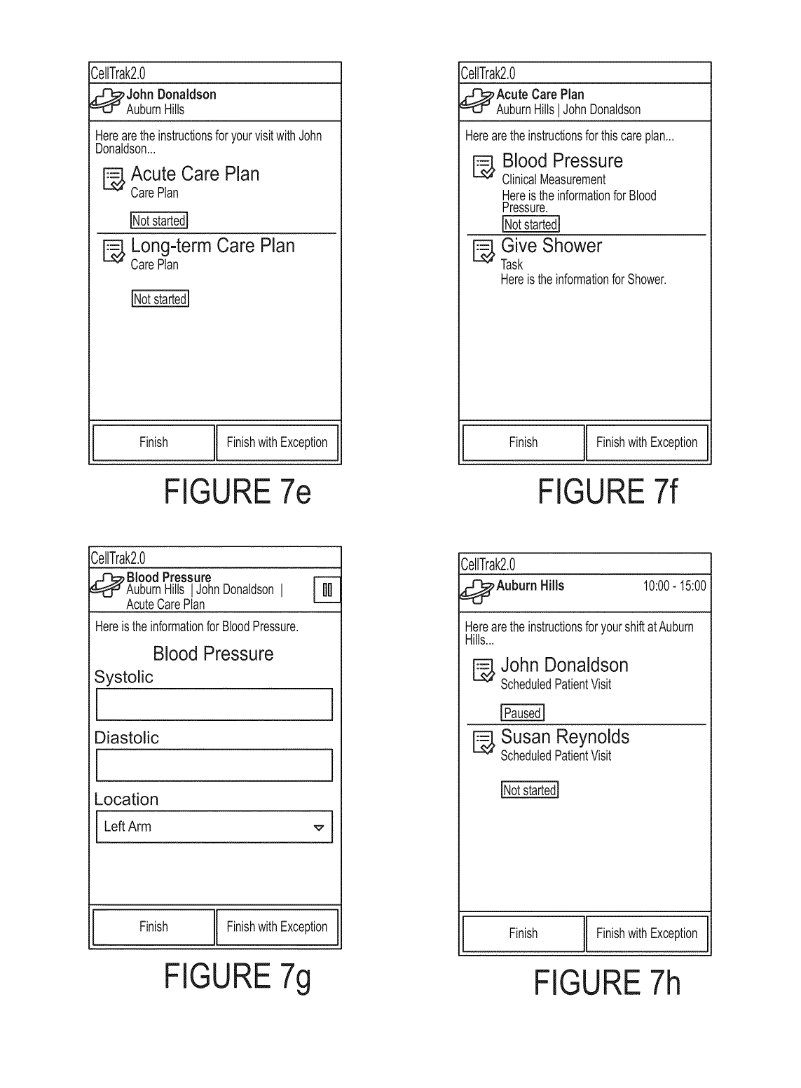

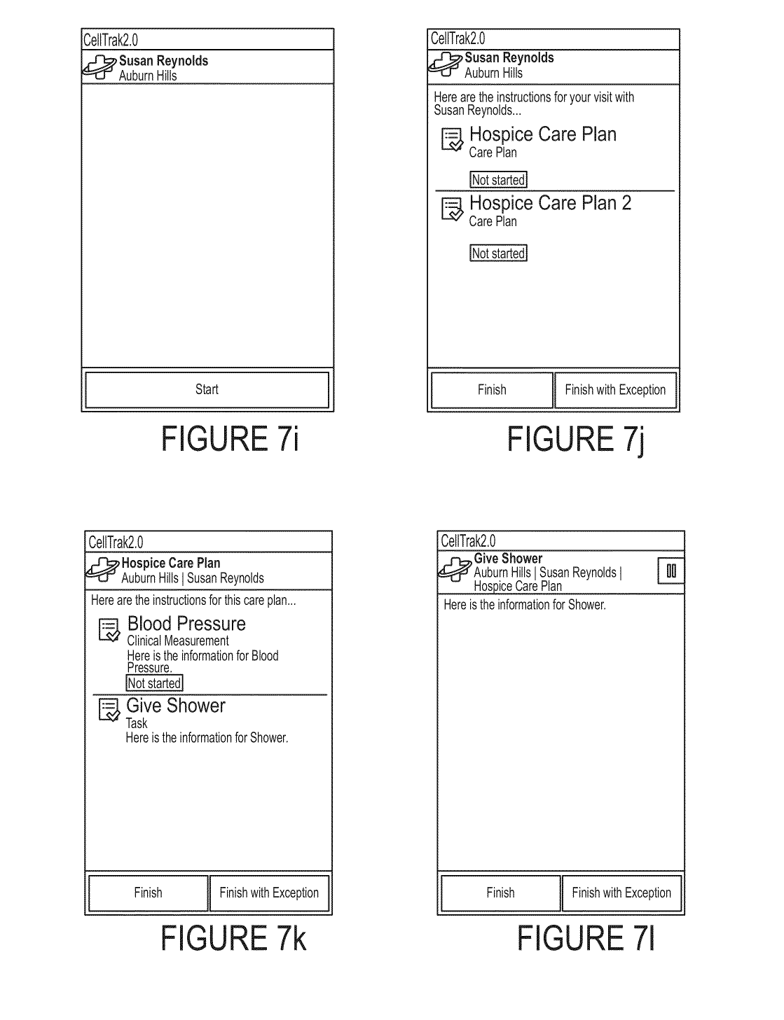

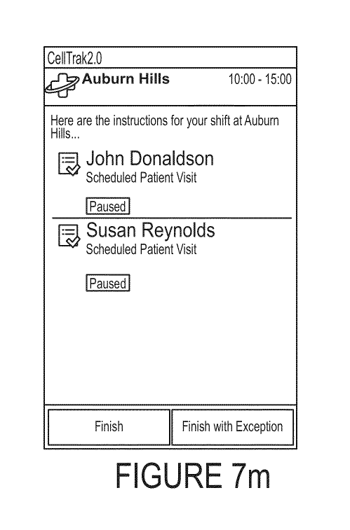

FIGS. 7a-7m show pictorial representations of a user interacting with a display screen for a mobile device, according to an example embodiment. In particular, FIG. 7a includes a plurality of possible options that a user may select when logging into or otherwise starting a shared care application. As illustrated in FIG. 7a, the care provider may select one or more schedules, check messages, run activities, view reports, etc.

FIG. 7b illustrates one or more group visits or shifts that may be available to the care provider upon logging into or otherwise starting the shared care application. As illustrated in FIG. 7b, additional information such as a start time and/or stop time associated with the shift may be displayed along with information indicative of the type of visit (e.g., patient visit, group visit, or other).

FIG. 7c includes a plurality of patient visits, which may be associated with the Auburn Hills group visit selected in FIG. 7b. In some embodiments, the group visit may include one or more patient visits. The patient visits may be associated with a time at which the patient visit may or must be performed. Patient visits may be displayed according to a fully or partially predetermined schedule or on an ad hoc basis. As illustrated, the care provider may be provided with a schedule of patient visits for the Auburn Hills shift. The care provider may select John Donaldson's patient visit from the schedule of patients.

As illustrated in FIG. 7d, upon selection of John's patient visit, the care provider may select to start John's patient visit. This selection may cause a start indicator to be initiated and optionally sent from the phone to a data center.

Once John's patient visit is initiated, the care provider may be presented with one or more care plans associated with John Donaldson. As illustrated in FIG. 7e, the plans may include, for example, an acute care plan and a long-term care plan.

As illustrated in FIG. 7f, upon selection of a care plan, the care provider may be presented with one or more tasks to perform. A task may include, for example, obtaining blood pressure measurements, giving the patient a shower, etc. In some embodiments, the shared care application may also allow the care provider to view additional details associated with the patient's care plan, which may include additional details about the patient, a history of previous tasks and/or care plans associated with the patient, etc.

In FIG. 7g, the care provider may be provided with prompts or other input mechanisms that may allow the care provider to provide data associated with the patient visit. As illustrated, prompts associated with blood pressure may include a location where the blood pressure was taken, as well as systolic and diastolic readings.

In embodiments, the care provider may select to start, finish, finish with exception, abort, pause, etc. the task, care plan, visit, and/or shift. In embodiments, all or a subset of the options may be presented or otherwise selectable during the patient visit. For example, if a patient visit has already been started, the care provider may not be able to select “start.” In another example, a care provider viewing a patient care plan may be provided limited options based on privacy restrictions, which may limit the care provider's access to patient information.

FIG. 7h includes a display, which may be presented to the care provider after a task and/or patient visit has been paused (e.g., after the care provider selects a pause option). Once paused, the care provider may select to continue the patient visit, start a different patient visit, etc. In some examples, this selection may be bypassed when the care provider has a single visit to complete, is working a single shift, or other shifts are not otherwise associated with the care provider. As illustrated in FIG. 7h, the care provider may select to start Susan Reynolds' visit.

FIG. 7i illustrates a care provider selecting to start Susan's patient visit after having paused one or more visits. At any point during Susan's Patient Visit, the care provider may choose to pause or end Susan's patient visit and either begin a new patient visit or resume a previously paused patient visit.

As illustrated in FIG. 7j, the care provider may be presented with instructions associated with Susan's visit, once initiated. In embodiments, the instructions may be associated with one or more care plans.

FIG. 7k illustrates one or more tasks that may be associated with Susan's hospice care plan. As illustrated, the tasks may include obtaining measurements, giving the patient a shower, etc.

FIG. 7l illustrates information that may be associated with a selected task, such as giving the patient a shower. In embodiments, the amount of information that is provided with the task may vary based on the complexity of the task, data required during implementation of the task, etc. Thus, a task such as giving a patient a shower may require little to no additional information, whereas other tasks may require additional information.

FIG. 7m illustrates a display, which may be presented to the care provider after a task and/or patient visit has been paused. As illustrated, the care provider has paused Susan's patient visit. The care provider may thereafter select to resume John or Susan's patient visits, finish a patient visit, start a new patient visit, etc.

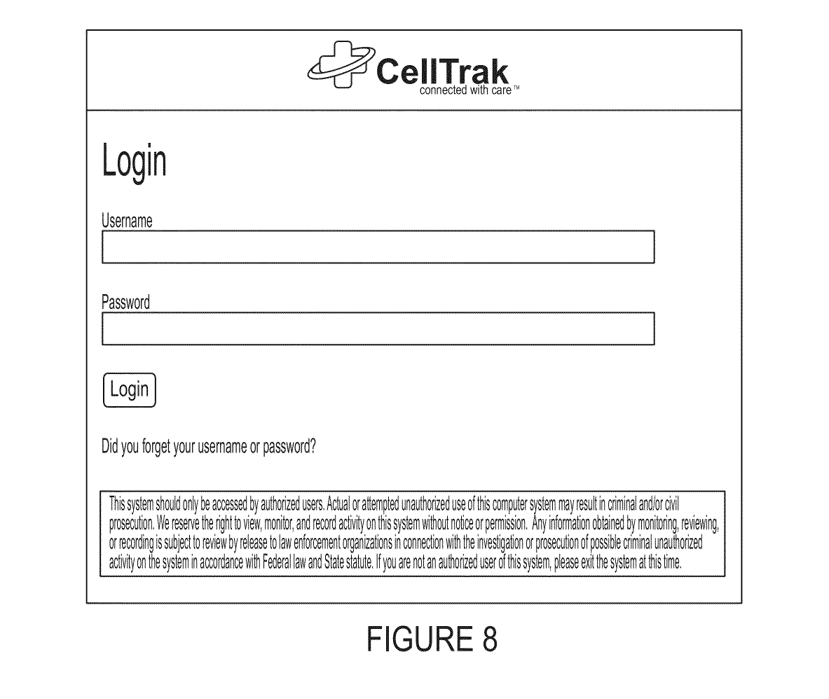

As discussed elsewhere herein, data associated with starting, pausing, resuming, or ending a patient visit and/or task may be sent to a data center. In embodiments, additional information such as data gathered during the patient visit may also be sent to the data center and/or otherwise associated with the patient object. Data sent to the data center may be accessible via a portal, as illustrated in part in FIGS. 8-13. Additional data, such as scheduling data, metrics associated with one or more patient care plans, billing information for each patient, shared care plan type, current status of a patient visit, amount of time allotted for one or more patient tasks, insurance provider, patient location, etc., may be stored at the data center (or other data location) and accessible by the portal.

FIG. 8 shows a pictorial representation of a display screen for a web portal server computer, illustrating a login screen according to an example embodiment. The login process may allow the user partial or full access to data located at one or more data centers.

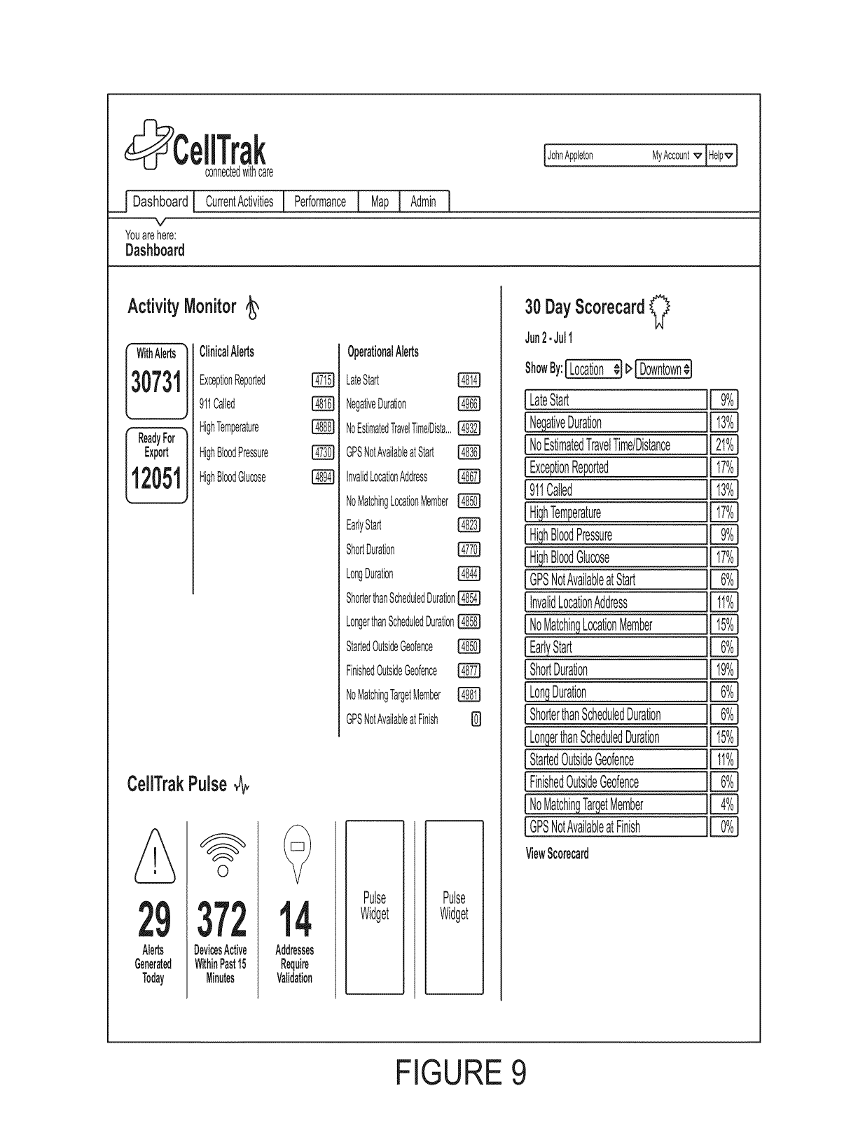

FIG. 9 shows a pictorial representation of a display screen for a web portal server computer, illustrating a dashboard screen according to an example embodiment. Specifically, FIG. 9 illustrates a 30 day scorecard displaying data associated with post-surgical tasks performed by one or more care providers. FIG. 9 also illustrates one or more clinical or operational alerts that may be generated at the portal based on data received during a patient visit. Example clinical alerts may include high blood glucose, high temperature, high blood pressure, 911 calls, etc. The clinical alerts may prompt a response to be sent to the care provider to take an action as part of the patient visit. As an example, the care provider may be sent a task to adjust a patient's insulin levels responsive to a high blood glucose level.

In embodiments, the dashboard may be specific to one or more locations, such as a building, neighborhood, town, city, county, state, etc. The data displayed on the dashboard may be filtered based on the selected location.

Operational alerts may also be generated and/or tracked at the portal. Example operational alerts may include finished outside geofence, started outside geofence, long duration, short duration, long visit, short visit, early start, late start, etc. For example, the data center may receive a start indicator and an associated start time indicative of a time at which a patient visit or task was initiated. The portal, via one or more modules, functions, etc., may compare the start time to a scheduled start time to determine whether the visit and/or task was initiated on time (e.g., as scheduled). If so, no alert may be triggered. If the visit and/or task were started early or late, then a respective early or late alert may be triggered and displayed via the dashboard. In embodiments, a start time occurring within a predetermined range may be considered an on-time start whereas a start time occurring outside of the range may be indicative of an early or late start, for example.

In another example, a long visit or a short visit may be sent as an alert. A long or short visit may be determined by comparing the total amount of time taken to complete a visit to an allotted time for the visit. The total amount of time may include the time from the visit being initiated (as determined via the start indicator and/or start time) until the time the visit was paused or ended. If the visit was paused, the total amount of time may further include the amount of time from the visit being resumed until it is paused or ended. This may continue until the visit is ended. The determined amounts of time may be added together to get a total amount of time, which may be used to determine if the care provider spent too much or too little time performing a patient visit. In embodiments, the lengths of the visits may be used to determine an amount of time that should be allotted in the future for the visit and/or task. Moreover, the visit length may also be used to determine how much is billed to the client and how much the care provider is paid.

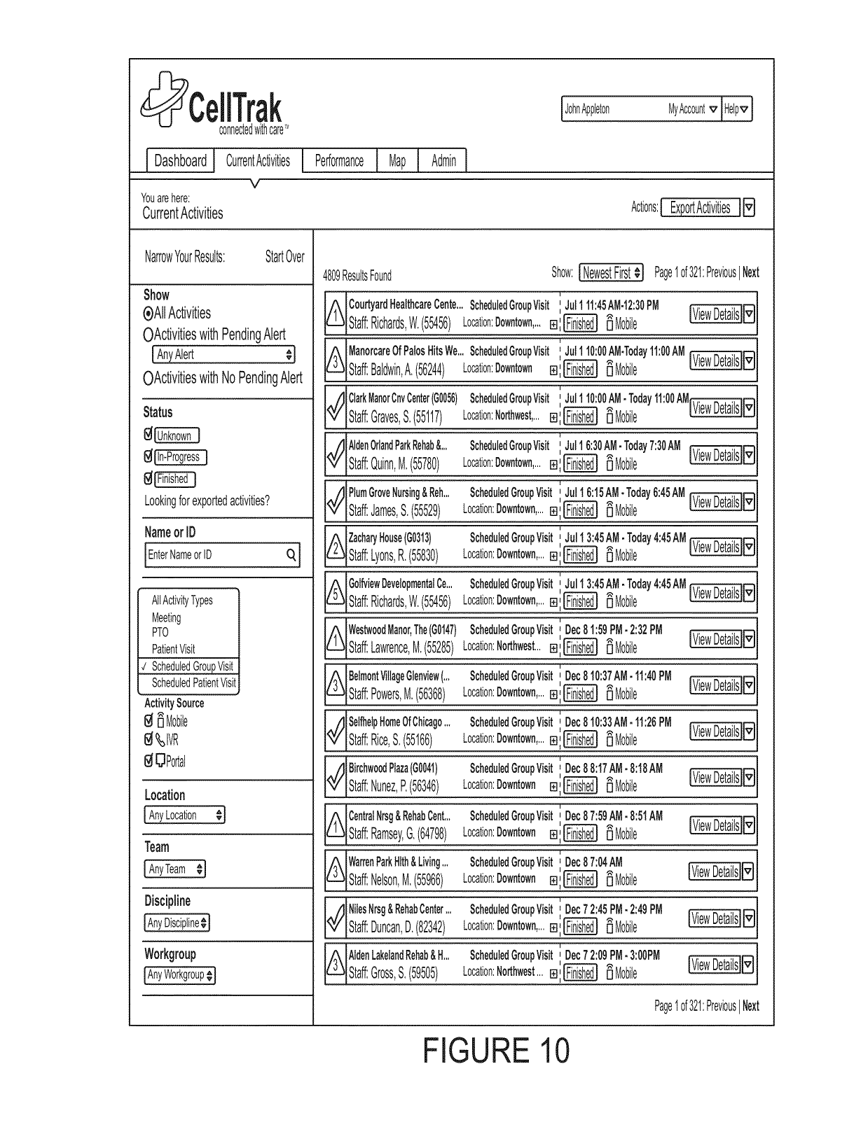

FIG. 10 shows a pictorial representation of a display screen for a web portal server computer, illustrating an activities screen for a team according to an example embodiment. The activities screen may include a list or summary of activities that are in progress, finished, and/or have an unknown status. In embodiments, the activities may include all activities, activities having one or more pending clinical or operational alerts, activities with no pending alerts, etc. The activities may optionally be filtered based on a specific date or date range, member, type of activity, etc. The results may be sortable and displayed to the user. As an example, a user may choose to view all shared care visit activities. The results may be displayed to the user and provide the user with an indication of which shared care locations have pending alerts, the care provider, the date and time that the shared care visit occurred, etc. The user may be able to view additional data via a view details option. In embodiments, the user may also be able to choose and/or customize a report having all or a subset of the activities data via an administration screen, for example.

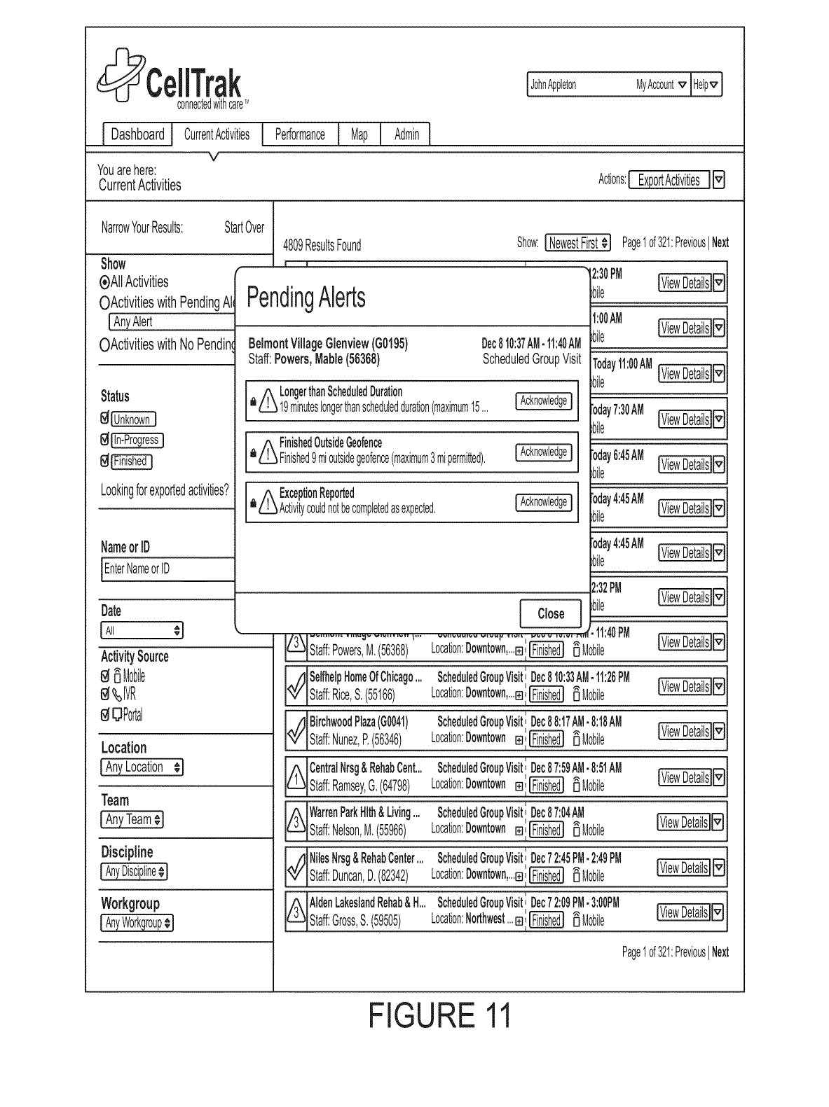

FIG. 11 shows a pictorial representation of a display screen for a web portal server computer, illustrating a pending alerts screen according to an example embodiment. As illustrated, the pending alerts screen may include clinical and/or operational alerts and may further include data associated with the pending alert. The pending alerts screen may be customized based on alert types chosen by the user. Optionally, alerts may be disabled or otherwise not enabled based on user preference and/or plan type. In embodiments, pending alerts may be removed by the user, exported to another format, etc.

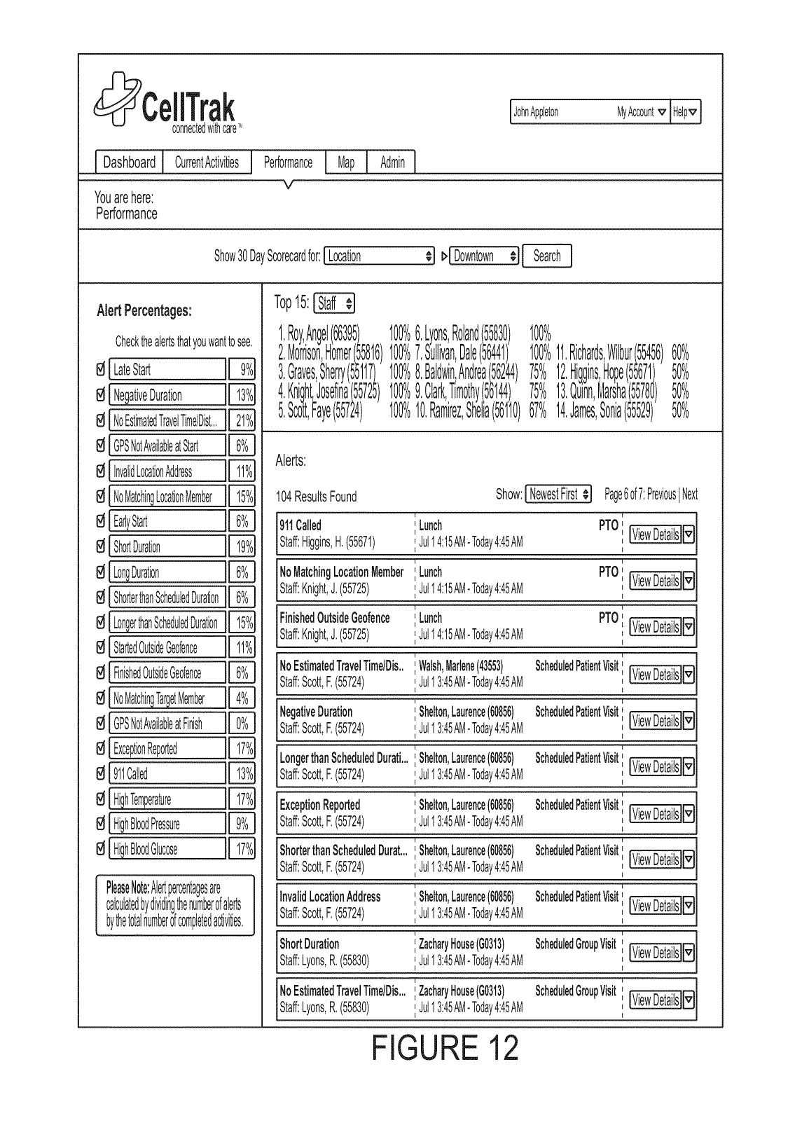

FIG. 12 shows a pictorial representation of a display screen for a web portal server computer, illustrating a performance screen according to an example embodiment. The performance screen may provide a general overview of performance metrics associated with a care provider, a location, etc. As an example, the performance screen may provide data for a location over a specified number of days, months, or years. Thus, data associated with downtown over the last 30 days may be displayed. Also displayed may be alert percentages including a frequency at which an alert occurs for the selected location and details associated with the alert. In embodiments, the performance screen may also display a percentage of a care provider's visits that result in one or more alerts. This information may be determined by the portal based on data from the data center, for example.

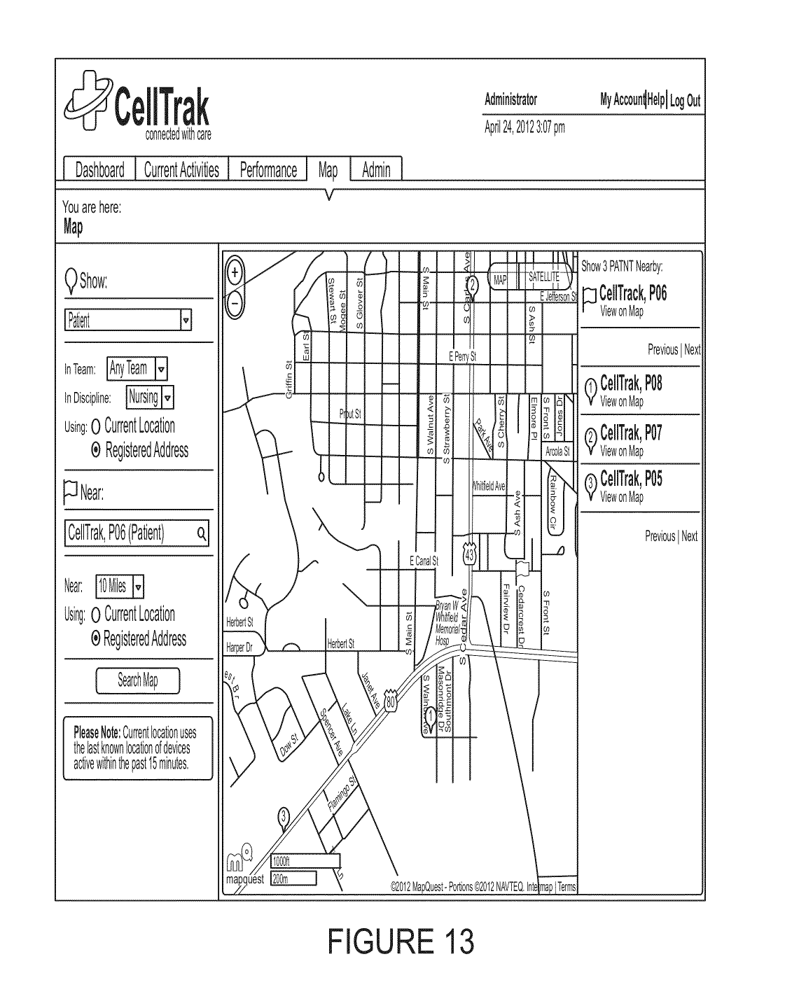

FIG. 13 shows a pictorial representation of a display screen for a web portal server computer, illustrating a map according to an example embodiment. The map may include shared care locations, patient locations, care provider locations, etc. The map may be used to identify care providers within a specified distance from the patient. Moreover, the map may be used to determine if the patient visit started and/or finished outside of a geofence around the patient and/or location. In embodiments, the portal, via the application server 114 or database server 120, may use the location data to create care provider schedules that may help provide patients with care providers in a timely and efficient manner.

### CONCLUSION

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

Since many modifications, variations, and changes in detail can be made to the described example, it is intended that all matters in the preceding description and shown in the accompanying figures be interpreted as illustrative and not in a limiting sense.

1. A method comprising:
receiving from a computing device data associated with a plurality of patients, including a first patient and a second patient;
identifying a task associated with the first patient and a task associated with the second patient;
determining that the task associated with the first patient has been initiated;
determining that the initiated task has been paused prior to completion of the initiated task;
determining that the initiated task has been resumed after performance of at least part of the task associated with the second patient;
determining a total time spent on the task associated with the first patient, wherein the total time includes a summation of a time spent prior to the initiated task being paused and a time spent after the initiated task being resumed;
generating an alert based on the total time; and
sending the generated alert to the computing device.

2. The method of claim 1, wherein generating the alert occurs when the total time exceeds a maximum threshold.

3. The method of claim 1, wherein generating the alert occurs when the total time is below a minimum threshold.

4. The method of claim 1, wherein receiving the data associated with the plurality of patients further comprises:
providing to the computing device a list of potential locations; and
receiving from the computing device a location selection identifying a location from the list of potential locations.

5. The method of claim 1, wherein receiving the data associated with the plurality of patients further comprises receiving satellite-based location data indicative of a location.

6. The method of claim 1, wherein receiving the data associated with the plurality of patients further comprises receiving location identification data from a radio-frequency identification tag.

7. The method of claim 1, wherein determining that the task associated with the first patient has been initiated further comprises receiving from the computing device a start-indicator and a start-time indicative of a time that the initiated task first began.

8. The method of claim 1, wherein determining that the initiated task has been paused prior to completion of the initiated task further comprises receiving from the computing device a pause-indicator and a pause-time indicative of a time that the initiated task was paused.

9. The method of claim 1, wherein determining that the initiated task has been resumed after performance of at least part of the task associated with the second patient further comprises receiving from the computing device a resume-indicator and a resume-time indicative of a time that the initiated task was resumed.

10. The method of claim 7, further comprising receiving from the computing device an end-indicator and an end-time indicative of a time that the initiated task was completed.

11. The method of claim 10, further comprising sending the generated alert to the computing device when more than a predetermined amount of time has elapsed since receipt of the start-indicator.

12. The method of claim 1, further comprising:
determining that the task associated with the second patient has been completed; and
determining a second total time taken to complete the task associated with the second patient.

13. A system comprising:
a computing system including a computer-readable memory; and
program instructions stored on the computer-readable memory and executable by at least one processor to cause the computing system to:
receive data associated with a plurality of patients, including a first patient and a second patient;
identify a task associated with the first patient and a task associated with the second patient;
determine a schedule for performing the task associated with the first patient and the task associated with the second patient;
detect that the task associated with the first patient has been initiated;
detect that the initiated task has been paused prior to completion;
responsive to the initiated task being paused, determine a modified schedule for performing the initiated task; and
detect that the initiated task has been resumed after performance of at least part of the task associated with the second patient.

14. The system of claim 13, further comprising program instructions stored on the computer-readable memory and executable by the computing system to:
determine whether the modified schedule is completed; and
responsive to the modified schedule being incomplete, send an alert to a computing device identifying at least one task that is incomplete.

15. The system of claim 13, further comprising program instructions stored on the computer-readable memory and executable by the computing system to:
determine a total time spent on the initiated task, wherein the total time includes a summation of a time spent prior to the initiated task being paused and a time spent after the initiated task being resumed.

16. A computer-readable memory having stored thereon instructions executable by a computing device having at least one processor to cause the computing device to perform functions comprising:
identifying a plurality of patients at a location;
identifying a plurality of tasks associated with the plurality of patients;
detecting that a first task of the plurality of tasks has been initiated;
detecting a pause of the first task, wherein the pause indicates that the first task has been stopped and is incomplete;
detecting a resumption of the first task, wherein the resumption occurs after a second task of the plurality of tasks has been initiated and is paused or completed;
receiving an indicator that the first task is complete; and
responsive to the first task being complete, determining whether to submit the completed task for payment.

17. The computer-readable memory of claim 16, wherein determining whether to submit the completed task for payment further comprises instructions executable by the computing device to cause the computing device to perform functions comprising:
determining a total time to complete the completed task;
comparing the total time to an allowable time to complete the first task; and
responsive to the total time being equal to the allowable time, submitting the completed task for payment.

18. The computer-readable memory of claim 17, further comprising instructions executable by the computing device to cause the computing device to perform functions comprising:
generating an alert when the total time to complete the completed task is one of (1) below a minimum threshold, or (2) above a maximum threshold.

19. The computer-readable memory of claim 16, further comprising instructions executable by the computing device to cause the computing device to perform functions comprising:
receiving one of (1) a location selection identifying the location from a list of potential locations, (2) satellite-based location data identifying the location, or (3) location data from a radio-frequency identification tag.

20. The computer-readable memory of claim 16, further comprising instructions executable by the computing device to cause the computing device to perform functions comprising:
identifying a patient of the plurality of patients based on one of (1) a patient selection identifying the patient from a list of potential patients, or (2) patient data from a radio-frequency identification tag.
